(19) United States
(12) Patent Application Publication
(10) Pub. No.: US 2009/0016866 A1
(43) Pub. Date: Jan. 15, 2009

(54) Manual Wheelchair Loader

(75) Inventors: David Zaragoza, Tampa, FL (US); Pedro Romero, Tampa, FL (US); Patrice Waller, Thonotosassa, FL (US); Josh Stuart, Lutz, FL (US); Michael Perez Cabezas, Tampa, FL (US)

Correspondence Address: SMITH HOPEN, PA, 180 PINE AVENUE NORTH, OLDSMAR, FL, 34677, US

(73) Assignee: UNIVERSITY OF SOUTH FLORIDA, Tampa, FL (US)

(21) Appl. No.: 11/623,471

(22) Filed: Jan. 16, 2007

Related U.S. Application Data
(60) Provisional application No. 60/758,884, filed on Jan. 13, 2006.

(51) Int. Cl. B60P 1/28

(52) U.S. Cl. 414/541

(57) ABSTRACT

A manual wheelchair loader design to lift and place an article, such as a collapsible wheelchair, into the cargo area of a vehicle. The loader includes a base adapted to rest on a substantially flat surface within the vehicle. At least one support arm is connected to the base to hold a carriage. The carriage is adapted to rotate between a first position and a second position. The carriage further has a lower support surface adapted to support the article being loaded when the frame is in a first position. The carriage also has a lateral support surface adapted to support the article being loaded when the carriage is in a second position. A ramp is hingedly connected to lower support surface for wheeling the article thereto.

### CROSS REFERENCE TO RELATED APPLICATIONS

This application claims priority to co-pending U.S. Patent Provisional Application 60/758,884, filed Jan. 13, 2006.

### FIELD OF THE INVENTION

The invention relates generally to the field of increasing handicap access. Specifically, the invention relates to a device for loading a manual-wheelchair into the trunk of an automobile.

### SUMMARY OF INVENTION

In a general embodiment, the invention includes a device for loading an article into a vehicle. The device includes a base adapted to rest on a substantially flat surface within the vehicle. At least one support arm is connected to the base to hold a carriage. The carriage is adapted to rotate between a first position and a second position. The carriage further has a lower support surface adapted to support the article being loaded when the frame is in a first position. The carriage also has a lateral support surface adapted to support the article being loaded when the carriage is in a second position. A ramp is hingedly connected to lower support surface for wheeling the article thereto.

In one embodiment, at least one support arm is adapted to extend the carriage between a retracted position and an extended position. A biasing mechanism, such as a spring or shock absorber, is disposed between at least one support arm and the base.

In another embodiment, the device comprises a plurality of horizontal support rods attached to the base to prevent side-to-side movement of the device during travel. Similarly, a plurality of vertical support rods is attached to the base to prevent up-and-down movement of the device during travel. The support rods are selected from the group consisting of telescoping rods and turnbuckle rods.

The base, generally, comprises a pair of lateral members and a pair of longitudinal members disposed at substantially right angles to the pair of lateral members. The device can be made for use in a number of vehicles by providing lateral and longitudinal members that are adjustable along their longitudinal axis.

### BRIEF DESCRIPTION OF THE DRAWINGS

For a fuller understanding of the nature and objects of the invention, reference should be made to the following detailed description, taken in connection with the accompanying drawings, in which:

FIG. 1 is a perspective view of the device showing a collapsible wheelchair as the article to be loaded.

FIG. 2A is a perspective view of the base.

FIG. 2B is a perspective view of the base showing horizontal and vertical support members.

FIG. 3A is a perspective view of the apparatus showing the carriage in the first position.

FIG. 3B is a perspective view of the apparatus showing the carriage in the second position.

FIG. 4A is a perspective view of the apparatus showing the carriage in the first-extended position.

FIG. 4B is a perspective view of the apparatus showing the carriage the second-extended position.

FIG. 4C is a perspective view of the apparatus showing the carriage in the second-retracted position.

### DETAILED DESCRIPTION OF THE PREFERRED EMBODIMENT

In the following detailed description of the preferred embodiments, reference is made to the accompanying drawings, which form a part hereof, and within which are shown by way of illustration specific embodiments by which the invention may be practiced. It is to be understood that other embodiments may be utilized and structural changes may be made without departing from the scope of the invention.

The present invention is a device adapted to manually load and unload an article into a vehicle. The embodiment described herein comprises a device specifically adapted for the loading and unloading of a collapsible wheelchair into the trunk of an automobile. This embodiment is illustrative and the device has equal utility with other articles such as crates, boxes and the like. The device can similarly be adapted to fit in another area of an automobile such as the cargo area of a van or the bed of a truck without deviating from the invention.

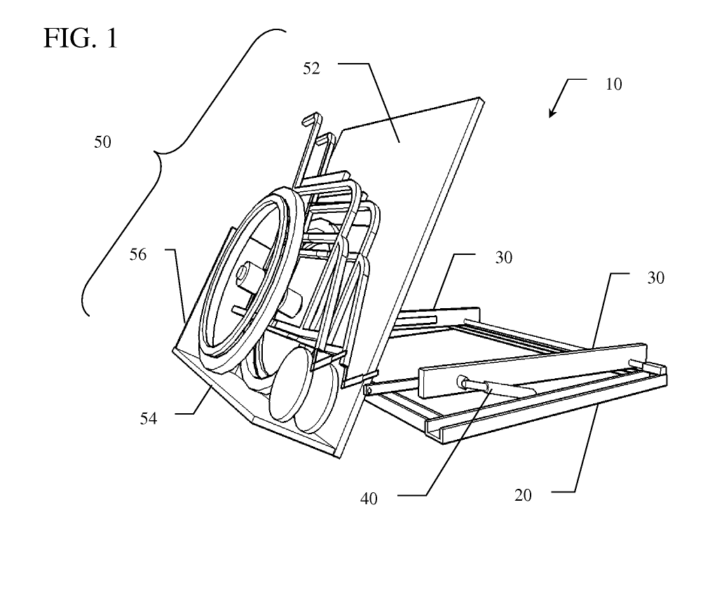

Turning now to FIG. 1, loading device 10 comprises base 20, extension arms 30, biasing device 40, and carriage 50. Carriage 50 further comprises lateral wall 52, lower wall 54 and ramp 56.

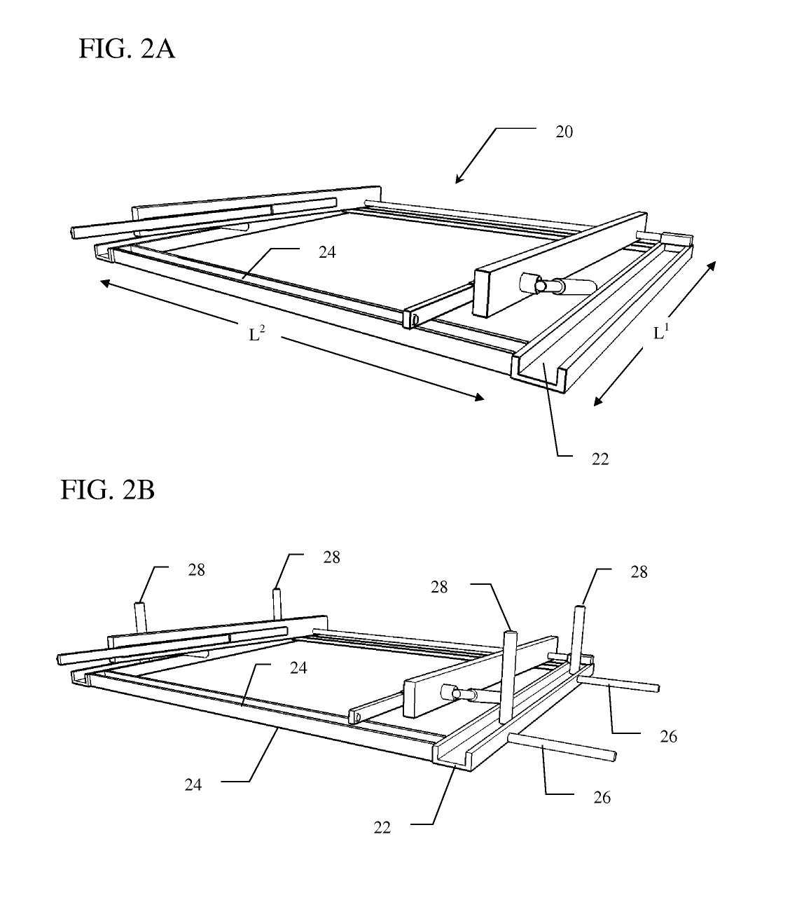

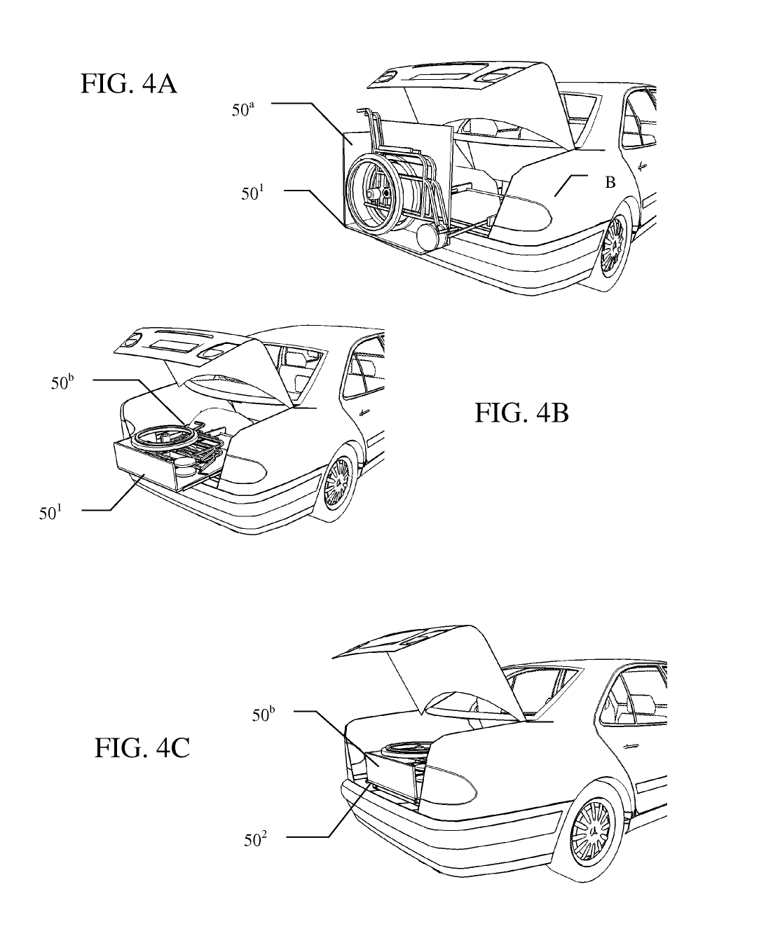

Base 20, shown in FIGS. 2A and 2B, rests upon a surface of the automobile, such as the floor of the trunk (see FIGS. 4A through 4C). Base 20 comprises a pair of lateral frame members 22, each having a longitudinal axis L¹, disposed at approximate right angles to a pair of longitudinal frame members 24, which have a longitudinal axis L². Base 20 can be secured to the vehicle in numerous ways including being mechanically fastened as with bolts, screws or welded. Alternatively, base 20 can be secured within the vehicle by a plurality of adjustable rods, not shown. Base 20 can also be adjusted to fit in numerous vehicles by altering the length of its longitudinal and lateral elements. In this manner, the width and/or length of the base can be depending on the type of vehicle being used. The longitudinal and lateral elements are, in a preferred embodiment, generally C-shaped in cross-section thereby defining a longitudinal slot which faces upward.

Horizontal securing rods 26, as shown in FIG. 2B, radiate from the sides of base 20 to secure the device against side-to-side movement; whereas vertical securing rods 28 radiating vertically from the base to prevent up and down movement when the automobile is in motion. The securing rods can take a number of forms to make the device adjustable. For example, each rod can be telescopically disposed, contain turnbuckle devices or incorporate ratchet and pawl system to adjust their length.

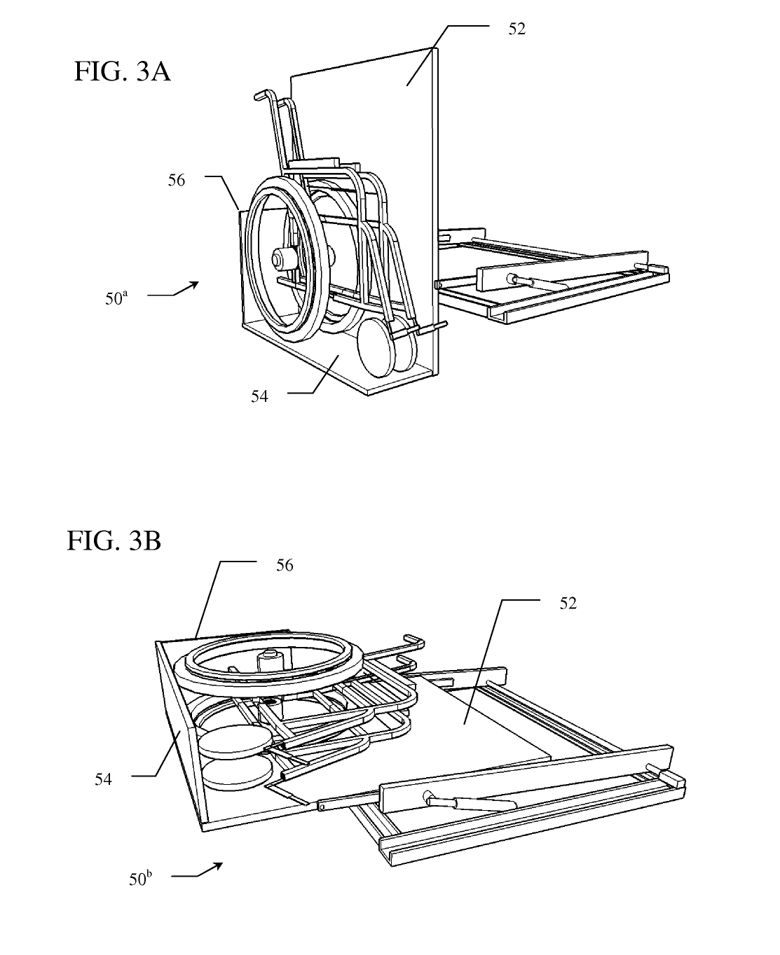

Carriage 50 is adapted to receive the article being loaded, here a collapsible wheelchair. As shown in FIGS. 3A and 3B the carriage is pivotable between a first position 50^{a} (FIG. 3A) in which lower wall 54 is substantially parallel to the ground and lateral wall 52 is substantially perpendicular to the ground. Lower wall 54 is substantially perpendicular to the ground and lateral wall 52 is substantially parallel to the ground in the second position 50^{b} (FIG. 3B). As it can be seen in the figured, the wheelchair is supported by lower wall 54 in the first, extended position and by lateral wall 52 in the second position.

Ramp 56 is hingedly connected to carriage 50 to assist with resting the wheelchair on lower wall 54. In use, ramp 56 is detached from lateral wall 52 at its upper and swung downward to provide an inclined surface upon which the wheelchair can be rolled. Once secured to carriage 50, ramp 56 is raised and latched to lateral wall 52.

With reference to FIGS. 4A through 4B, the carriage is longitudinally slidably connected to base 20 through extension arms 30 (FIGS. 1 through 2B). This allows the carriage to travel between extended position 50¹ (FIGS. 4A and 4B), wherein the carriage is at its greatest distance from the opposite side of the base, and a retracted position 50² (FIG. 4C), wherein the carriage is at its closest distance from the opposite side of the base. In a preferred embodiment, the carriage contains safety measures which only allow the carriage to rotate between first position 50^{a} and second position 50^{b} when it is longitudinally disposed in extended position 50¹.

In an alternate embodiment, also shown in FIGS. 2A and 2B, extension arms 30 are pivotally connected at one end to base 20. This allows the end of the extension arms distal to the pivotal connection to be raised so that the carriage can slide over the rear wall of the vehicle's trunk. Biasing mechanism 40 is provided between each extension arm 30 and base 20 to make the rotation of extension arms 30 easier. Biasing mechanism 40 can be any mechanism known in the art which provides controlled assistance to the raising a lowering of extension arms 30.

For example, biasing device 40 can be a dampening device similar to a shock absorber. Where the dampening device is rated for a weight to be just below that of the wheelchair, the weight of the chair will compress the dampening device slowly and provide the control necessary to safely lower the carriage (50) to the floor of the trunk. Similarly, the close relation between the load tolerance of the dampening device and the weight of the wheelchair means that little force is needed to raise carriage 50 and slide it out of the trunk. It is also possible to employ a leaf-spring for use as the biasing device. It is also possible to adapt the frame such that biasing mechanism pulls upward on extension arms 30 such as will a coil or spring, rather than pushing as in the previous example. Such an adaptation would be easily recognized by one skilled in the art.

To provide the longitudinal-sliding motion for carriage 50, extension arms 30 can be formed in numerous ways. For example, extension arms 30 can be telescopically disposed or can be formed of numerous elements such as a support arm 32 and a sliding arm 34. Sliding arm can be a unitary device or can be a sliding mechanism, similar to sliding hardware used in drawers and the like, affixed to support arm 32.

It will be seen that the advantages set forth above, and those made apparent from the foregoing description, are efficiently attained and since certain changes may be made in the above construction without departing from the scope of the invention, it is intended that all matters contained in the foregoing description or shown in the accompanying drawings shall be interpreted as illustrative and not in a limiting sense.

It is also to be understood that the following claims are intended to cover all of the generic and specific features of the invention herein described, and all statements of the scope of the invention which, as a matter of language, might be said to fall there between. Now that the invention has been described,

What is claimed is:

1. A device for loading an article into a vehicle, comprising:
a base;
at least one support arm connected to the base;
a carriage, adapted to rotate between a first position and a second position, attached to at least one support arm;
the carriage further comprising a lower support surface adapted to support the article being loaded when the frame is in a first position;
the carriage comprising a lateral support surface adapted to support the article being loaded when the carriage is in a second position.

2. The device of claim 1 wherein at least one support arm is adapted to extend the carriage between a retracted position and an extended position.

3. The device of claim 1 further comprising a biasing mechanism disposed between at least one support arm and the base.

4. The device of claim 3 wherein the biasing mechanism is selected from the group consisting of shock absorbers, multi-motion gas springs and a leaf spring.

5. The device of claim 1 further comprising a ramp hingedly connected to the lower support surface.

6. The device of claim 1 further comprising a plurality of horizontal support rods attached to the base.

7. The device of claim 6 wherein the horizontal support rods are selected from the group consisting of telescoping rods and turnbuckle rods.

8. The device of claim 1 further comprising a plurality of vertical support rods attached to the base.

9. The device of claim 8 wherein the vertical support rods are selected from the group consisting of telescoping rods and turnbuckle rods.

10. The device of claim 1 wherein the base further comprises:
a pair of lateral members; and
a pair of longitudinal members disposed at substantially right angles to the pair of lateral members.

11. The device of claim 10 wherein the lateral members are adjustable along their longitudinal axis.

12. The device of claim 10 wherein the longitudinal members are adjustable along their longitudinal axis.
